(19) United States
(12) Patent Application Publication
(10) Pub. No.: US 2005/0119448 A1
(43) Pub. Date: Jun. 2, 2005

(54) Method of producing lactic acid

(75) Inventors: Katsuhiro Matsuda, Tokyo (JP); Takenobu Kawano, Kanagawa (JP); Hitoshi Horie, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/030,145

(22) Filed: Jan. 7, 2005

(30) Foreign Application Priority Data
Jan. 14, 2002 (JP) 2004-006312

(51) Int. Cl. C08G 63/08

(52) U.S. Cl. 528/354

(57) ABSTRACT

By allowing cellulose and a base to coexist in water at a reaction temperature of not less than 150° C. but less than 400° C. at a pressure of 5 MPa or more, the cellulose is directly degraded into lactic acid. The weight ratio of the base relative to the cellulose is within the range from 0.5 to 8.

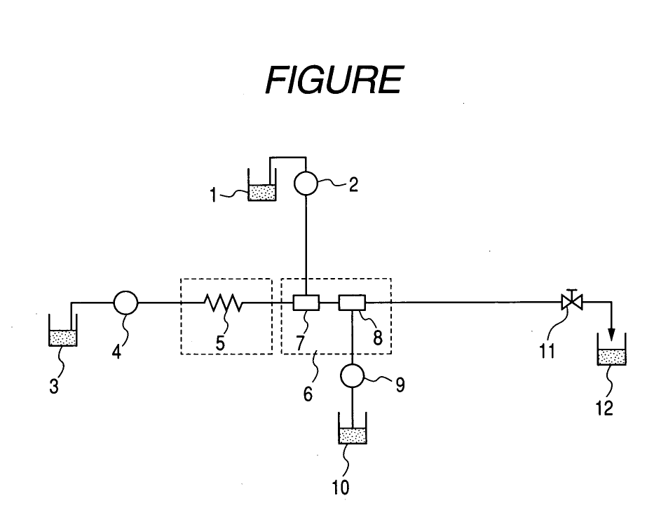

### BACKGROUND OF THE INVENTION

1. Field of the Invention

The present invention relates to a method of producing lactic acid from cellulose.

2. Related Background Art

Hitherto, lactic acid has been obtained by hydrolyzing starch by use of an acid or enzyme to produce a sugar such as glucose and effecting lactic acid fermentation of the sugar.

Lactic acid has an application as a material for poly(lactic acid) as a biodegradable plastic.

Japanese Patent Application Laid-Open No. 2002-238590 (referred to as “Patent Document 1”) describes a method of producing lactic acid from waste paper in which cellulose is subjected to a saccharification reaction by use of cellulase enzyme and then lactic acid fermentation is effected to produce lactic acid.

Further, New Development in Glycochemistry in Supercritical Water Reaction Field (“Reaction Control at Single Molecule/Atom Level”, Theme Symposium 2: Frontiers of Physical Chemistry, Impact of Nanomaterial Discovery, Lecture Notes, 2002, 9-12 (referred to as “Non-patent Document 1”)) describes a degradation mechanism of cellulose by supercritical water oxidation. In addition, Mitsuru Sasaki, Tadafumi Adschiri, and Kunio Arai, Ind. Eng. Chem. Res., 39(8), 2883-2890 (2000) (referred to as “Non-patent Document 2”) describes the distribution of degradation products of cellulose by subcritical and supercritical water oxidation. As described in these documents, in the degradation of cellulose with supercritical water, hydrolysis and retroaldol reactions proceed simultaneously to provide various products.

In the method as described in Patent Document 1, an enzyme is used, so that the reaction time is long. Further, attention needs to be given to the reaction environment, and environments such as temperature and pH needs to be strictly controlled, thus making the procedure complicated. Moreover, an apparatus for effecting an enzyme reaction therein will be large in size.

In Non-patent Documents 1 and 2, although the reaction temperature and reaction pressure are regulated to control retro-aldol and dehydration reactions, lactic acid cannot selectively be obtained.

### SUMMARY OF THE INVENTION

It is an object of the present invention to provide a method of producing lactic acid in which cellulose can be degraded into lactic acid in a single process.

Therefore, the present invention provides a method of producing lactic acid from cellulose, comprising allowing cellulose and a base to coexist in water at a reaction temperature of not less than 150° C. but less than 400° C. at a pressure of 5 MPa or more, thereby directly degrading the cellulose into lactic acid.

The present invention is further characterized in that the base exists in a weight that is 0.5 to 8 times the weight of the cellulose.

According to the present invention, lactic acid can directly be obtained from cellulose in a short period of time.

### BRIEF DESCRIPTION OF THE DRAWINGS

FIGURE is a schematic view showing a lactic acid production apparatus according to an embodiment of the present invention.

### DESCRIPTION OF THE PREFERRED EMBODIMENTS

(1) The present invention is a method of producing lactic acid from cellulose, comprising allowing cellulose and a base to coexist in water at a reaction temperature of not less than 150° C. but less than 400° C. at a pressure of 5 MPa or more, thereby directly degrading the cellulose into lactic acid.

In addition, in the present invention,

(2) it is preferred that the base exists in a weight that is 0.5 to 8 times the weight of the cellulose.

(3) it is also preferred that the cellulose is an organic material derived from an organism.

(4) it is further preferred that the organic material derived from an organism is paper.

The invention is further described in detail below.

In the method of producing lactic acid according to an embodiment of the present invention, the raw material used is cellulose. Cellulose and sodium hydroxide are added to water, and the cellulose is impregnated with the water (hereinafter referred to as “cellulose/base-containing water”) prior to degradation. The content of cellulose in the cellulose/base-containing water is, for example, 1 weight/volume percent (w/v %) . Further, the content of the base is 4 w/v %. Additional water is added to this cellulose/base-containing water. This additional water is of a temperature of 250° C. and a pressure of 25 MPa. By adding this additional water, cellulose will be exposed to a high temperature and a high pressure and rapidly degraded to produce lactic acid in a short period of time (approximately within 30 seconds). The conversion rate is approximately 40.2%.

Then, the cellulose/base-containing water will be described.

Cellulose is obtained from cutting waste paper and has a fine state in which fibers themselves are also cut. Accordingly, the cellulose/base-containing water is in a state of opaque slurry.

The term “base” as employed herein encompasses an inorganic base such as potassium hydroxide and sodium hydroxide, and an organic base such as tetramethylammonium hydroxide and tetraethylannmonium hydroxide.

Further, the cellulose/base-containing water is brought into contact in a high-pressure state with the additional water. The reason for this is that because the additional water is in a high-pressure state, it is naturally necessary also for the cellulose/base-containing water to be in a high-pressure state. The pressure range of the cellulose/base-containing water is 5 MPa or more.

Moreover, the cellulose and the base need only to be mixed prior to being exposed to the additional water, so that they may be provided in a pre-mixed state or be provided separately and then mixed together in channels.

In addition, as described in the examples described below, even if the base is used in a weight that is more than 8 times the weight of the cellulose, the produced amount of lactic acid does not change. Therefore, it is disadvantageous from the viewpoint of production cost to increase the amount of the base added above the 8 times. On the other hand, if the base is used in a weight that is less than 0.5 times the weight of the cellulose, the produced amount of lactic acid decreases. Accordingly, it is preferred that the base is 0.5-8 times the cellulose in terms of weight. Specifically, in the case where the cellulose concentration is 1 w/v %, the preferred range of concentration of the base is from 0.5 w/v % to 8 w/v %.

Then, the additional water will be described.

Additional water is ordinary water.

This additional water is brought into a (high temperature)/(high pressure) state and supplied to the cellulose/base-containing water.

This additional water is at a pressure within the range of 5 MPa or more and at a temperature within the range of not less than 150° C. but less than 400° C.

The temperature and/or pressure of each of the additional water and the cellulose/base-containing water may independently be assigned.

The numerical ranges of pressure and temperature of the environment in which additional water and cellulose/base-containing water are mixed together to degrade cellulose into lactic acid will be described.

The preferred numerical range of the temperature is such that the temperature of the reaction field is within the range of not less than 150° C. but less than 400° C. On the other hand, the preferred numerical range of the pressure of the reaction field is 5 MPa or more.

Because when the temperature is less than 150° C. the produced amount of lactic acid is small, and because when the temperature is 400° C. or more the produced lactic acid will be degraded, it is preferred to adopt a temperature of not less than 150° C. but less than 400° C.

In addition, when the pressure is less than 5 MPa, the conditions come close to those establishing a gaseous phase and the temperature/pressure becomes unstable, and when the pressure is 35 MPa or more, the characteristics of water of a high temperature and a high pressure facilitate metal oxidation, thereby posing a problem of corrosion of the apparatus. It is, therefore, preferred to adopt the pressure range of not less than 5 MPa but less than 35 MPa.

It is preferred to use the additional water such that the temperature and the pressure of the reaction field fall within the above numerical ranges. This realizes the state such that when merely left at room temperature the water containing cellulose and a base will not degrade, but addition of the additional water allows degradation to occur only at necessary time, thus making the degradation reaction controllable. It is preferred to prepare additional water of a high temperature to raise the temperature of water containing cellulose and a base. In this case, the additional water may be heated to a temperature within the above numerical range of temperature. Needless to say, water containing cellulose and a base per se may also be heated.

Lowering the temperature can stop the reaction. Specifically, even if the pressure is within the above numerical range, only lowering the temperature will stop the reaction. More specifically, the water containing cellulose and a base may be allowed to radiate heat to stop the reaction. Alternatively, to the water containing cellulose and a base of a predetermined pressure, cooling water may be added after or during the degradation of cellulose to completely stop the reaction. In the case of the present embodiment, the degradation time may suitably be determined by adjusting the flow rate of the water containing cellulose and a base flowing through a pipe and the length and thickness of the pipe. In any case, degradation can be achieved in a far shorter period of time compared to known techniques.

Although in the present embodiment the cellulose is in a very fine state in which fibers themselves are also cut, the present invention encompasses use of waste paper or the like that is so cut as so have a large size of, for example, about 0.5 mm×0.5 mm square. In this case, the cellulose/base-containing water may not give a suspension derived from cellulose. Further, fibers do not necessarily need to be cut, and water giving a suspension with cellulose is also available.

In the present embodiment, the method is described in which additional water is used, the additional water and cellulose/base-containing water are brought into contact with each other in a state in which the additional water and the cellulose/base-containing water are brought into approximately the same pressure and only the additional water is heated. However, as long as cellulose can be degraded at a high temperature and a high pressure, for example, use of additional water may be omitted and only the cellulose/base-containing water may be brought into a high-temperature/high-pressure state to degrade cellulose to lactic acid.

In the present embodiment, a configuration may be adopted in which a field for joining flows of the two types of water together, or in which one water is supplied into a field housing the other water.

Although in the present embodiment cellulose was obtained from waste paper, cellulose may also be obtained from plants such cotton, leaves, wood, or potato, or animals, so long as it is obtained from the so-called organic materials derived from organisms. However, waste paper is especially preferred because excess impurities are removed in papermaking processes and therefore cellulose of a high purity can be obtained. The term “waste paper” employed herein includes waste paper having images or characters formed thereon by electrophotography or ink-jet printing.

Lactic acid obtained in the present embodiment can be used to prepare poly(lactic acid), which in turn can be utilized to obtain another compound or can be used together with another material to provide, for example, a product-forming material or transmissive material.

The term “product-forming material” is intended to mean, for example, a housing, more specifically a frame member for an electrophotographic or ink-jet image formation device.

The term “transmissive material” is intended to mean, for example, a material that can transmit radio waves or light and includes a material provided on the front of a receiving or transmitting portion of an infrared sensor, a material provided on the front of a receiving or transmitting portion of a photosensor, or a material used for a member requiring transparency in terms of designing such as a finder of a camera.

A lactic acid production apparatus for carrying out the method of producing lactic acid according to the present embodiment will be described.

The single FIGURE is a schematic view showing a lactic acid production apparatus according to an embodiment of the present invention. In the FIGURE, reference numeral 1 denotes a container, 2 denotes pump-A, 3 denotes a container, 4 denotes pump-B, 5 denotes a heating means, 6 denotes a reactor, 7 denotes a mixer, 8 denotes a cooling water mixer, 9 denotes pump-C, 10 denotes a container, 11 denotes a pressure-reducing valve, and 12 denotes a container. The reactor 6 comprises the mixer 7 and the cooling water mixer 8.

The cellulose/base-containing water is contained in the container 1. The cellulose/base-containing water is pumped up with the pump-A 2 from the container 1, and supplied in a high-pressure state to the mixer 7 via a channel.

The additional water is contained in the container 3. The additional water is pumped up with the pump-B 4 from the container 3, and supplied in a high-pressure state to the mixer 7 via a channel.

Between the pump-B 4 and the mixer 7 in the channel, the heating means 5 is disposed. The additional water is heated by the heating means 5 prior to being supplied to the mixer 7.

The cellulose/base-containing water and the additional water are mixed in the mixer 7. The pressure inside the mixer 7 is 25 MPa and the temperature is 350° C. In the mixed water, cellulose is degraded to produce lactic acid. The degradation reaction occurs in the channel connecting the mixer 7 to the cooling water mixer 8. That is to say, the cooling water mixer 8 serves to stop the degradation reaction.

The cooling water mixer 8 is connected to the pump-C 9 via a channel, and the pump-C 9 pumps up the cooling water contained in the container 10 and supplies it in a high-pressure state to the mixed water. By supplying the cooling water to the mixed water, the degradation reaction is stopped.

The cooled mixed water containing the cooling water further flows via a channel and is reduced in pressure (opened to atmosphere) by the pressure-reducing valve 11 and then contained in the container 12.

The cooled mixed water contained in the container 12 comprises lactic acid, which can be recovered by a known method.

### EXAMPLES

Examples and a comparative example are shown below. However, the following examples and comparative example are not to limit the present invention. In other words, the present invention is not to be limited to the experimental conditions adopted in the following examples and comparative example.

First, a comparative example in which only cellulose is used without adding any base will be described.

### Comparative Example 1

1 w/v % of cellulose-containing water was fed from the container 1 with the pump-A 2 at a flow rate of 2 mL/min, and mixed in the mixer 7 with water fed from the container 3 with the pump-B 4 at a flow rate of 4 mL/min. The temperature of the reactor 7 at this time was 350° C. and the pressure was 25 MPa.

The mixed water was further mixed in the cooling water mixer 8 with water sent from the container 10 with the pump-C 9 at a flow rate of 8 mL/min to stop the degradation reaction. At this time, the reaction time corresponding to the period of time required for the finally mixed water to flow from the mixer 7 to the cooling water mixer 8 was 1.06 seconds.

From the liquid that has further flowed through the channel and was contained in the container 12, only 0.2 mmol/L of lactic acid was obtained.

Next, examples in which a base is added will be described.

### Example 1

To water, cellulose and sodium hydroxide were added to prepare a cellulose/base-containing water having a cellulose concentration of 1 w/v % and a sodium hydroxide concentration of 4 w/v %. This cellulose/base-containing water was fed from the container 1 with the pump-A 2 at a flow rate of 2 mL/min and mixed in the mixer 7 with water fed from the container 3 with the pump-B 4 at a flow rate of 4 mL/min. The temperature of the reactor at this time was 250° C. and the pressure was 25 MPa.

This mixed water was further mixed in the cooling water mixer 8 with water fed from the container 10 with the pump-C 9 at a flow rate of 8 mL/min to stop the degradation reaction. The reaction time between the mixer 7 and the cooling water mixer 8 was 1.06 seconds.

From the liquid that has further flowed through the channel and was contained in the container 12, 6.7 mmol/L of lactic acid was obtained.

This means that 8.4 mg of lactic acid was produced from 20 mg of cellulose, per minute.

### Example 2

Lactic acid was produced following the same procedure as in Example 1 with the exception that the base concentration was 0.5 w/v % and the reactor temperature was 400° C., with the result that 1.92 mmol/L of lactic acid was obtained.

Similar experiments were carried out at other concentrations, and the conversion rate from cellulose to lactic acid was classified according to the concentrations of coexisting sodium hydroxide (Table 1). The “conversion rate” as employed herein is determined by dividing the number of moles of lactic acid actually obtained by the number of moles of lactic acid theoretically obtainable from the number of moles of cellulose loaded and expressing the quotient in terms of percentage. Further, the number of moles of lactic acid theoretically obtainable will be specifically described. The number of moles of cellulose is converted into number of moles of glucose. On the assumption from the numbers of carbon atoms thereof that one glucose produces two lactic acids, the conversion rate was calculated.

### Example 3

Lactic acid was produced following the same procedure as in Example 2 with the exception that the base concentration was twice that in Example 2, with the result that the conversion rate from cellulose to lactic acid did not considerably change.

### Example 4

Lactic acid was produced following the same procedure as in Example 2 with the exception that the cellulose concentration was 0.1 w/v %, with the result that the produced amount of lactic acid was small. From this result, the lower limit value of base added was determined to be 0.5 w/v %.

It can be seen from Table 1 that when the base was co-present at 0.5 w/v %, the conversion rate from cellulose to lactic acid was approximately 7 times that in the case where any base was not present. Further, when the base concentration was 4 w/v %, the conversion rate was approximately 19 times that in the case where any base was not present. From Examples 1 and 2, it can be seen that increasing the base concentration increased the conversion rate from cellulose to lactic acid.

### Example 5

The results obtained by varying the pressure are shown in Table 2. Varying the pressure did not considerably change the conversion rate from cellulose to lactic acid. However, when the reaction pressure was less than 5 MPa, the pressure and temperature were unstable. This is because the additional water and cellulose/base-containing water became close to a gaseous phase state.

TABLE 1
Conversion Rates from Cellulose to Lactic Acid
under Different Conditions

| | | Cellulose | | Base | | | Lactic Acid | |
|---|---|---|---|---|---|---|---|---|
| | Reaction | Concentration*¹/ | | Concentration/ | Pressure/ | Temperature/ | Concentration/ | Conversion |
| | Time/s | w/v % | Base | w/v % | MPa | ° C. | w/v % | Rate/% |
| Comparative | 1.06 | 0.143 | None | 0 | 25 | 300 | tr. | 0 |
| Example 1 | | | | | | 350 | 0.0006 | 0.4 |
| | | | | | | 400 | 0.002 | 1.6 |
| Example 1 | 1.06 | 0.143 | NaOH | 4 | 25 | 150 | 0.04 | 26.4 |
| | | | | | | 250 | 0.045 | 40.2 |
| | | | | | | 300 | 0.044 | 29.2 |
| | | | | | | 350 | 0.047 | 31 |
| | | | | | | 400 | 0.035 | 23.5 |
| Example 2 | 1.06 | 0.143 | NaOH | 0.5 | 25 | 300 | 0.015 | 10 |
| | | | | | | 350 | 0.015 | 9.9 |
| | | | | | | 400 | 0.017 | 11.5 |
| Example 3 | 1.06 | 0.143 | NaOH | 8 | 25 | 300 | 0.044 | 29.2 |
| | | | | | | 350 | 0.051 | 34.1 |
| | | | | | | 400 | 0.037 | 24.6 |
| Example 4 | 1.06 | 0.143 | NaOH | 0.1 | 25 | 250 | n.d | n.d |
| | | | | | | 300 | 0.003 | 1.8 |
| | | | | | | 350 | 0.002 | 1.6 |
| | | | | | | 400 | 0.003 | 2 |

*¹Cellulose concentration when 1 w/v % of cellulose-containing water or cellulose/base-containing water is mixed with additional water and cooling water.

TABLE 2
Conversion Rates from Cellulose to Lactic Acid
under Different Pressures

| | | Cellulose | | Base | | | Lactic Acid | |
|---|---|---|---|---|---|---|---|---|
| | Reaction | Concentration*¹/ | | Concentration/ | Pressure/ | Temperature/ | Concentration/ | Conversion |
| | Time/s | w/v % | Base | w/v % | MPa | ° C. | w/v % | Rate/% |
| Example 5 | 1.06 | 0.143 | NaOH | 4 | 150 | 5 | 0.057 | 38 |
| | | | | | | 10 | 0.044 | 29.6 |
| | | | | | | 15 | 0.045 | 30 |
| | | | | | | 20 | 0.045 | 29.7 |
| | | | | | | 25 | 0.04 | 26.4 |

*¹Cellulose concentration when 1 w/v % of cellulose-containing water or cellulose/base-containing water is mixed with additional water and cooling water.

This application claims priority from Japanese Patent Application No. 2004-006312 filed on Jan. 14, 2004, which is hereby incorporated by reference herein.

1. A method of producing lactic acid from cellulose, comprising allowing cellulose and a base to coexist in water at a reaction temperature of not less than 150° C. but less than 400° C. at a pressure of 5 MPa or more, thereby directly degrading the cellulose into lactic acid.

2. The method according to claim 1, wherein the base exists in a weight that is 0.5 to 8 times the weight of the cellulose.
